(19) United States
(12) Patent Application Publication
(10) Pub. No.: US 2012/0101791 A1
(43) Pub. Date: Apr. 26, 2012

(54) CONTROLLING SIMULATION SYSTEMS

(75) Inventors: Hideaki Komatsu, Kanagawa (JP); Shingo Nagai, Kanagawa (JP); Fumitomo Ohsawa, Kanagawa (JP)

(73) Assignee: INTERNATIONAL BUSINESS MACHINES CORPORATION, Armonk, NY (US)

(21) Appl. No.: 13/246,052

(22) Filed: Sep. 27, 2011

(30) Foreign Application Priority Data
Oct. 20, 2010 (JP) 2010-235295

(51) Int. Cl. G06G 7/48

(52) U.S. Cl. 703/6

(57) ABSTRACT

A method for controlling a simulation system includes storing first-stage and second stage tables in which a value of a predicted time until arrival of an I/O instruction and a type of the instruction are included as entries for each program counter of an instruction set simulator, and in which a value of an earliest time until an output event from a peripheral simulator is included as an entry for each type of instruction; looking up the first-stage table to obtain the type of the instruction and the value of the predicted time until arrival of the instruction, looking up the second-stage table with reference to the obtained type of the instruction to obtain the value of the earliest time until the output event from the peripheral simulator, and returning the predicted time until arrival of the instruction and the earliest time until the output event from the peripheral simulator.

PRIORITY

This application claims priority to Japanese Patent Application No. 2010-235295, filed 20 Oct. 2010, and all the benefits accruing therefrom under 35 U.S.C. §119, the contents of which in its entirety are herein incorporated by reference.

### BACKGROUND

The present invention relates to a simulation of a physical system such as an automobile, and more particularly to a software-based simulation system.

In their first years in the early 20th century, automobiles were composed of mechanical parts, including an engine as a power source, a brake, an accelerator, a steering wheel, a transmission, and a suspension. Few electric mechanisms were used except for engine plug ignition and headlights.

Since around the 1970's, a need for efficient engine control has arisen in order to prepare for situations such as air pollution and oil crises. As such, an electronic control unit (ECU) has been in use for engine control. An ECU generally includes an input interface that subjects an input signal from a sensor to, e.g., analog-to-digital (A/D) conversion, a logical processor (a microcomputer) that processes the digital input signal according to a predetermined logic, and an output interface that converts the result of the processing into an actuator activation signal.

Components of recent automobiles now expand to not only control systems such as those for an engine and a transmission, Anti-lock Breaking System (ABS), Electronic Stability Control (ESC), and power steering, but also wiper control and a security monitoring system. Thus, besides mechanical parts, electronics parts and software constitute a significant percentage of recent automobiles. It is said that the development cost for the latter accounts for 25% or even 40% of the entire development cost. For a hybrid-type automobile, it accounts for 70%.

An automobile includes mechanical parts (plants), including power equipment such as an engine, power transmission equipment, traveling equipment such as a steering gear, braking equipment, and other parts such as a body system. Operations of these plants are dynamically determined by programs of 30 to 70 or more electronic control units (ECUs) according to sensor inputs (such as a speed) and human inputs (such as acceleration).

Basically, each ECU controls operations of one plant. For example, an engine control unit determines the amount and timing of fuel injection and ignition for the engine by way of software. Since the control is software-based, in a luxury car like one with “sport” mode, the amount of fuel injection can be increased or decreased depending on the mode. Also, the number of engine revolutions can be adjusted through automatic blipping (idling of the engine) with the downshift timing. In this case, an ECU for the engine and an ECU for the transmission need to cooperate. An ESC (Electronic Stability Control) system for preventing incidents such as a skid of an automobile additionally requires cooperation with braking equipment such as a brake, leading to complicated ECU software. It is to be noted that these “interventional” functions can be readily removed because the functions are software-based.

To bring out the maximum performance of the plants and also safely operate the plants, it is important to perform thorough tuning and testing of operation parameters in the process of ECU software design and development. Generally, repeating the tuning and testing after prototyping an actual automobile takes too much cost and time. A desired approach is to virtually implement controllers and plants in a computing device before prototyping and run the controllers and the plants with high speed and accuracy to check the operations. Such ECU simulations are based on four types of schemes: (1) Model-in-the-Loop Simulation (MILS), in which operations of controllers are logically represented in a representation form such as a state machine, (2) Software-in-the-Loop Simulation (SILS), in which hardware constraints such as data accuracy are partially introduced into the logical operations, (3) Processor-in-the-Loop Simulation (PILS) or Virtual Hardware-in-the-Loop Simulation (V-HILS), in which software is fully implemented to emulate ECU processors, and (4) Hardware-in-the-Loop Simulation (HILS), in which an ECU board is fully implemented to connect to a real-time plant simulation. A simulation becomes closer to a prototype in this order.

MILS/SILS are mainly used for a trial-and-error phase intended for bringing out the basic performance of the plants. However, since these schemes behave differently from the software actually installed in the ECUs, these schemes cannot be used for product verification. V-HILS is regarded as extremely promising as a scheme for discovering and solving unwanted operations (bugs) of the software because this scheme uses completed ECU software. However, in no cases has V-HILS been implemented as a scheme that achieves reproducible behaviors. HILS is always performed for final check of operations of a finished ECU board. However, HILS cannot be used for debugging purposes because this scheme does not guarantee reproducibility when a failure is found.

Thus, the configuration of HILS as it is, i.e., the configuration of HILS loosely coupled with the ECU board and plant simulators cannot directly realize consistent behaviors even when each component is speeded up. Realizing the consistency in the order of communication is necessary for achieving the reproducibility of behaviors. V-HILS, in particular, is expected to solve this problem.

A typical configuration of V-HILS according to conventional concepts consists of a plurality of ECU emulators, a plurality of plant simulators, and a global scheduler that schedules the entire operations.

The ECU emulators consist of processor emulators and peripheral emulators. The plant simulators include simulators such as a brake simulator and an engine simulator.

A processor emulator operates at a relatively high resolution clock, for example 80 MHz. A plant simulator, which is a simulator of a physical mechanism, operates at a relatively low resolution clock, for example 10 KHz. Since a lower resolution generally enables a faster simulation, the plant simulator is often faster.

The plant simulator does not necessarily repeat numerical calculations in a fixed-length processing step time, and often requires variable steps for suppressing the effect of calculation errors or for adapting to the timing of discontinuous changing points. In any case, in each step, the plant simulator receives an instruction signal from a controller and outputs the internal state to a sensor. The instruction signal often takes a pulse shape in order to represent ON and OFF of a switch.

A peripheral emulator corresponds to an interface section of I/O of an ECU emulator and interconnects the plant simulator with the processor emulator. The peripheral emulator can be considered to operate typically (on average) at a resolution of about 10 MHz. This is faster than the plant simulator but slower than the processor emulator. The peripheral emulator sends a pulse signal to the plant simulator. The peripheral emulator also reads the internal state as quantitative data from the plant simulator.

Viewed from one aspect, the peripheral is the center of the system, interconnecting a plant with a processor and interconnecting processors. Given a temporal resolution enough for discriminating the order of signals passing through the peripheral, the order can be correctly reproduced with respect to the interactions of the plant and the processor. However, as the time taken until a next signal determines the data accuracy (such as in the calculation of the speed), a higher temporal resolution is more preferable. That is, the magnitude of a data error depends on the temporal resolution.

In addition to the data error problem, there is also an overhead problem. In an approach in which a fixed synchronization interval is set, shortening the synchronization interval allows more correct operations. However, this conversely increases the overhead required for synchronization processing, thereby increasing the time required for the entire processing.

Therefore, an approach involving fixing the synchronization interval to a minimum length cannot be a realistic solution from both viewpoints of data errors and the overhead.

As will be understood from the above, increasing the speed of a simulation requires reducing the synchronization frequency. For this purpose, the timing of output events between simulators or emulators needs to be predicted.

In a transaction-level simulation, the output timing is predictable because an output event is registered at the time of input. However, an ISS (Instruction Set Simulator), which is an ECU emulator or a processor emulator, does not know the output timing until execution, so that only the ISS disadvantageously cannot perform event synchronization. This becomes a cause of preventing a speedup of the simulation with I/O clock accuracy.

In Japanese Patent Laid-Open No. 2007-11720 as conventional art of V-HILS, a problem to be solved is to make the configuration of a system simulator flexibly changeable while supporting a complicatedly configured system. The conventional art discloses that a system simulator is configured with three types of simulators: an instruction set simulator that simulates CPU operations, a bus simulator that simulates bus operations, and a peripheral simulator that simulates peripheral operations, and an interface is provided between simulators for allowing referring to and changing the state of each simulator. However, the conventional art suggests no techniques of optimizing synchronization between the peripheral and the CPU or ECU.

Japanese Patent Laid-Open No. 2010-134839 discloses a computer-implemented simulation system, including: a continuous-system simulator; a discrete-system simulator; edge storing means for storing time-stamped information about an edge signal of a pulse sent from the continuous-system simulator to the discrete-system simulator; means for storing an event occurrence time of the discrete-system simulator as a rollback-capable time; searching means for responding to a rollback operation of the continuous-system simulator to search the rollback-capable time of the discrete-system simulator precedent to the time of the occurrence of the rollback; and means for reading the edge signal corresponding to the rollback-capable time found by the searching means from the edge storing means and sending the edge signal to the discrete-system simulator. Particularly, means such as the edge storing means are recorded as a table. However, the conventional art also suggests no solutions to the problem of reducing the synchronization frequency between the peripheral and the ECU.

### SUMMARY

In one embodiment, a method is disclosed for controlling a simulation system including a plant simulator, an instruction set simulator, a peripheral simulator, and a scheduler that run on a computer, wherein an interrupt signal is input to the instruction set simulator, the instruction set simulator inputs an I/O instruction to the peripheral simulator, the peripheral simulator inputs a pulse signal to the plant simulator, and the scheduler provides an instruction to advance operations of the plant simulator, the instruction set simulator, and the peripheral simulator. The method includes storing, in a storage device of the computer, a first-stage table in which a value of a predicted time until arrival of an I/O instruction and a type of the I/O instruction are included as entries for each program counter of the instruction set simulator; storing, in the storage device of the computer, a second-stage table in which a value of an earliest time until an output event from the peripheral simulator is included as an entry for each type of I/O instruction; the scheduler querying the plant simulator, the instruction set simulator, and the peripheral simulator for a next event time; the plant simulator returning a pre-calculated next event time in response to the query from the scheduler; the peripheral simulator returning a pre-calculated next event time in response to the query from the scheduler; the instruction set simulator, in response to the query from the scheduler, looking up the first-stage table with reference to a value of the program counter to obtain the type of the I/O instruction and the value of the predicted time until arrival of the I/O instruction, looking up the second-stage table with reference to the obtained type of the I/O instruction to obtain the value of the earliest time until the output event from the peripheral simulator, and returning a sum of the value of the predicted time until arrival of the I/O instruction and the value of the earliest time until the output event from the peripheral simulator as a next event time; and the scheduler advancing a simulation to an earliest event time among the next event times returned from the plant simulator, the instruction set simulator, and the peripheral simulator.

In another embodiment, a non-transitory, computer readable medium containing computer readable instructions stored thereon that, when executed by a computer, implement a method for controlling a simulation system including a plant simulator, an instruction set simulator, a peripheral simulator, and a scheduler that run on a computer, wherein an interrupt signal is input to the instruction set simulator, the instruction set simulator inputs an I/O instruction to the peripheral simulator, the peripheral simulator inputs a pulse signal to the plant simulator, and the scheduler provides an instruction to advance operations of the plant simulator, the instruction set simulator, and the peripheral simulator. The method includes storing, in a storage device of the computer, a first-stage table in which a value of a predicted time until arrival of an I/O instruction and a type of the I/O instruction are included as entries for each program counter of the instruction set simulator; storing, in the storage device of the computer, a second-stage table in which a value of an earliest time until an output event from the peripheral simulator is included as an entry for each type of I/O instruction; the scheduler querying the plant simulator, the instruction set simulator, and the peripheral simulator for a next event time; the plant simulator returning a pre-calculated next event time in response to the query from the scheduler; the peripheral simulator returning a pre-calculated next event time in response to the query from the scheduler; the set simulator, in response to the query from the scheduler, looking up the first-stage table with reference to a value of the program counter to obtain the type of the I/O instruction and the value of the predicted time until arrival of the I/O instruction, looking up the second-stage table with reference to the obtained type of the I/O instruction to obtain the value of the earliest time until the output event from the peripheral simulator, and returning a sum of the value of the predicted time until arrival of the I/O instruction and the value of the earliest time until the output event from the peripheral simulator as a next event time; and the scheduler advancing a simulation to an earliest event time among the next event times returned from the plant simulator, the instruction set simulator, and the peripheral simulator.

In another embodiment, a simulation system includes a plant simulator, an instruction set simulator, a peripheral simulator, and a scheduler that run on a computer, wherein an interrupt signal is input to the instruction set simulator, the instruction set simulator inputs an I/O instruction to the peripheral simulator, the peripheral simulator inputs a pulse signal to the plant simulator, and the scheduler provides an instruction to advance operations of the plant simulator, the instruction set simulator, and the peripheral simulator; a storage device; a first-stage table stored in the storage device and including a value of a predicted time until arrival of an I/O instruction and a type of the I/O instruction as entries for each program counter of the instruction set simulator; a second-stage table stored in the storage device of the computer and including a value of an earliest time until an output event from the peripheral simulator as an entry for each type of I/O instruction; the scheduler having a function of querying the plant simulator, the instruction set simulator, and the peripheral simulator for a next event time; the plant simulator having a function of returning a pre-calculated next event time in response to the query from the scheduler; the peripheral simulator having a function of returning a pre-calculated next event time in response to the query from the scheduler; and the instruction set simulator having a function of, in response to the query from the scheduler, looking up the first-stage table with reference to a value of the program counter to obtain the type of the I/O instruction and the value of the predicted time until arrival of the I/O instruction, looking up the second-stage table with reference to the obtained type of the I/O instruction to obtain the value of the earliest time until the output event from the peripheral simulator, and returning a sum of the value of the predicted time until arrival of the I/O instruction and the value of the earliest time until the output event from the peripheral simulator as next event time, wherein the scheduler further has a function of advancing a simulation to an earliest event time among the next event times returned from the plant simulator, the instruction set simulator, and the peripheral simulator.

In another embodiment, a method is disclosed for controlling a simulation system including a plant simulator, an instruction set simulator, a peripheral simulator, and a scheduler that run on a computer, wherein an interrupt signal is input to the instruction set simulator, the instruction set simulator inputs an I/O instruction to the peripheral simulator, the peripheral simulator inputs a pulse signal to the plant simulator, and the scheduler provides an instruction to advance operations of the plant simulator, the instruction set simulator, and the peripheral simulator. The method includes storing, in a storage device of the computer, an event prediction table in which a value of a predicted time until arrival of an I/O instruction is included as an entry for each program counter of the instruction set simulator; the scheduler querying the plant simulator, the instruction set simulator, and the peripheral simulator for a next event time; the plant simulator returning a pre-calculated next event time in response to the query from the scheduler; the peripheral simulator returning a pre-calculated next event time in response to the query from the scheduler; the instruction set simulator, in response to the query from the scheduler, looking up the event prediction table with reference to a value of the program counter to obtain the value of the predicted time until arrival of the I/O instruction and returning the obtained value as a next event time; and the scheduler advancing a simulation to an earliest event time among the next event times returned from the plant simulator, the instruction set simulator, and the peripheral simulator.

In still another embodiment, a non-transitory, computer readable medium contains computer readable instructions stored thereon that, when executed by a computer, implement a method for controlling a simulation system including a plant simulator, an instruction set simulator, a peripheral simulator, and a scheduler that run on a computer, wherein an interrupt signal is input to the instruction set simulator, the instruction set simulator inputs an I/O instruction to the peripheral simulator, the peripheral simulator inputs a pulse signal to the plant simulator, and the scheduler provides an instruction to advance operations of the plant simulator, the instruction set simulator, and the peripheral simulator. The method includes storing, in storage device of the computer, an event prediction table in which a value of a predicted time until arrival of an I/O instruction is included as an entry for each program counter of the instruction set simulator; the scheduler querying the plant simulator, the instruction set simulator, and the peripheral simulator for a next event time; the plant simulator returning a pre-calculated next event time in response to the query from the scheduler; the peripheral simulator returning a pre-calculated next event time in response to the query from the scheduler; the instruction set simulator, in response to the query from the scheduler, looking up the event prediction table with reference to a value of the program counter to obtain the value of the predicted time until arrival of the I/O instruction and returning the obtained value as a next event time; and the scheduler advancing a simulation to an earliest event time among the next event times returned from the plant simulator, the instruction set simulator, and the peripheral simulator.

### BRIEF DESCRIPTION OF SEVERAL VIEWS OF THE DRAWINGS

FIG. 1 is a block diagram showing a configuration of exemplary hardware for implementing embodiments of the present invention;

FIG. 2 is a block diagram showing a configuration of an exemplary functional configuration for implementing embodiments of the present invention;

FIG. 3 is a flowchart of a process of generating a first-stage table;

FIG. 4 is a flowchart of a process of generating the first-stage table;

FIG. 5 is a flowchart of a process of generating a second-stage table;

FIG. 6 is a diagram showing a relationship between the first-stage table and the second-stage table;

FIG. 7 is a diagram showing a flowchart of simulation operations;

FIG. 8 is a diagram showing timing in the simulation operations according to the present invention; and

FIG. 9 is a diagram showing timing in conventional typical simulation operations.

### DETAILED DESCRIPTION

Configurations and processes in an embodiment of the present invention will be described below with reference to the drawings. The following description assumes that like symbols refer to like elements throughout the drawings unless otherwise specified. It is to be understood that the configurations and processes will be described here merely as an embodiment and the technical scope of the present invention is not intended to be construed exclusively within the embodiment.

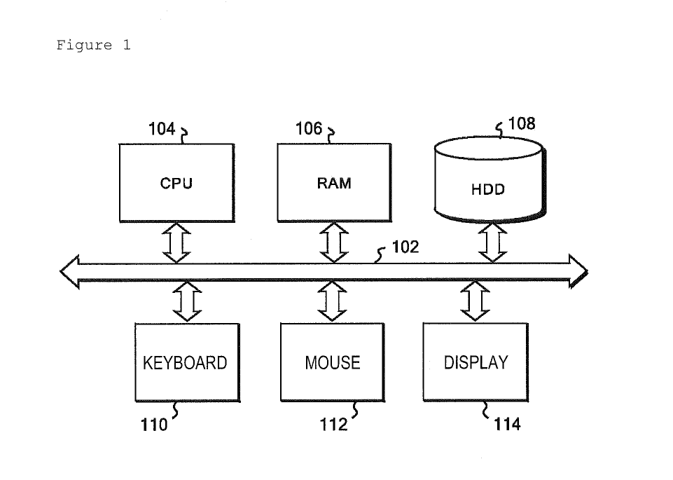

With reference to FIG. 1, a block diagram of computer hardware for implementing a system configuration and processes according to an embodiment of the present invention is shown. In FIG. 1, a CPU 104, a main memory (RAM) 106, a hard disk drive (HDD) 108, a keyboard 110, a mouse 112, and a display 114 are connected to a system bus 102. The CPU 104, preferably based on a 32-bit or 64-bit architecture, may be Pentium™ 4 of Intel Corporation, Core™ 2 DUO, Core™ 2 quad, or Xeon™ of Intel Corporation, or Athlon™ of Advanced Micro Devices, Inc., for example. The main memory 106 preferably has a capacity of 2 GB or more, or more preferably a capacity of 4 GB or more.

The hard disk drive 108 stores an operating system. The operating system may be any one compatible with the CPU 104, such as Linux™, or Windows 7, Windows XP™, or Windows™ 2000 of Microsoft Corporation, or Mac OS™ of Apple Inc.

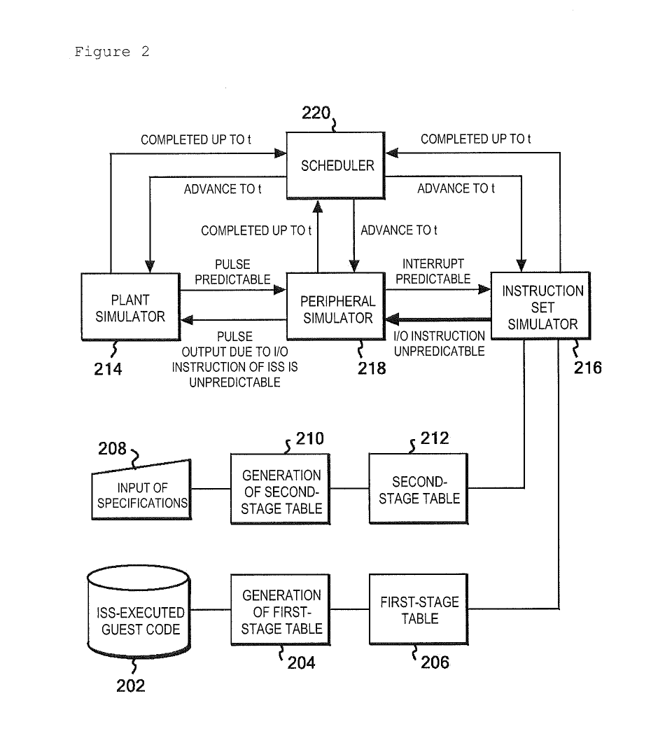

The hard disk drive 108 further stores: program code 202 executed by an instruction set simulator 216; a first-stage table generation module 204; a generated first-stage table 206; a file 208 of information about peripheral simulator specifications; a second-stage table generation module 210; a generated second-stage table 212; a plant simulator 214; the instruction set simulator 216; a peripheral simulator 218; and a scheduler 220, all of which will be described below in connection with FIG. 2.

The first-stage table generation module 204 and the second-stage table generation module 210 may be written in any program language, such as C, C++, C#, or Java®.

The first-stage table 206 and the second-stage table 212 are stored in the hard disk drive 108 in any format capable of tabular representation, such as CSV or XML. The first-stage table 206 and the second-stage table 212 are preferably loaded into the main memory 106 before a simulation to be readily accessed by the instruction set simulator 216.

The plant simulator 214 is preferably generated with a continuous-value simulation modeling system such as MATLAB®/Simulink®. The peripheral simulator 218 is a transaction-type emulator and preferably generated with SystemC/TLM. The instruction set simulator (ISS) 216 is also called a processor emulator. In an automobile system, the ISS 216 serves as an ECU for controlling a plant such as an engine or a brake.

The keyboard 110 and the mouse 112 are used for purposes such as starting a simulation and inputting certain parameters according to a graphic user interface provided by the operating system.

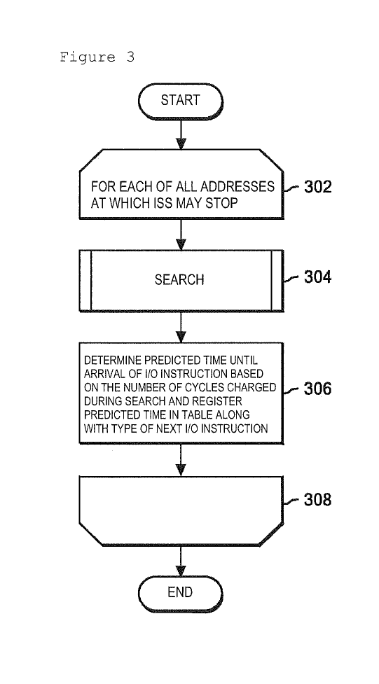

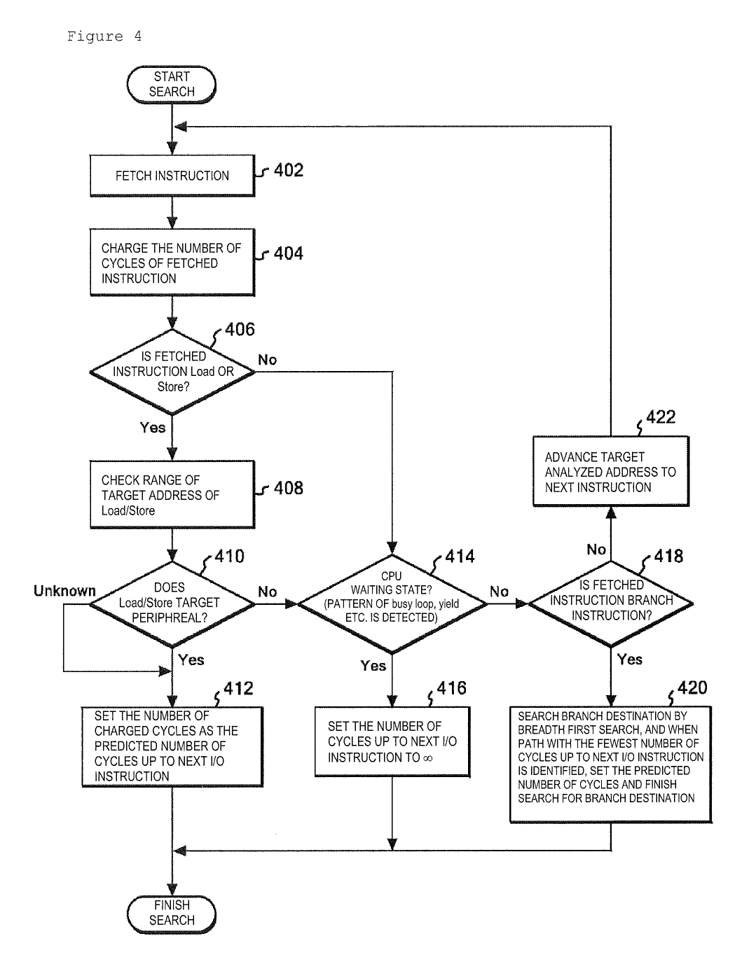

Now, a functional configuration for implementing the present invention will be described with reference to a block diagram of FIG. 2. In FIG. 2, the ISS-executed guest code 202 is code executed by the instruction set simulator (ISS) 216 and is preferably executable binary code. The first-stage table generation module 204 statically analyzes the ISS-executed guest code 202 in the order of instruction addresses to generate the first-stage table 206, which is then written to the hard disk drive 108 and stored therein. The process of generating the first-stage table 206 will be described below with reference to flowcharts in FIGS. 3 and 4.

A block labeled as input of specifications 208 represents input preferably based on a file in a certain format in which specifications of the peripheral simulator 218 is written. Alternatively, the specifications may be manually input with the keyboard 110.

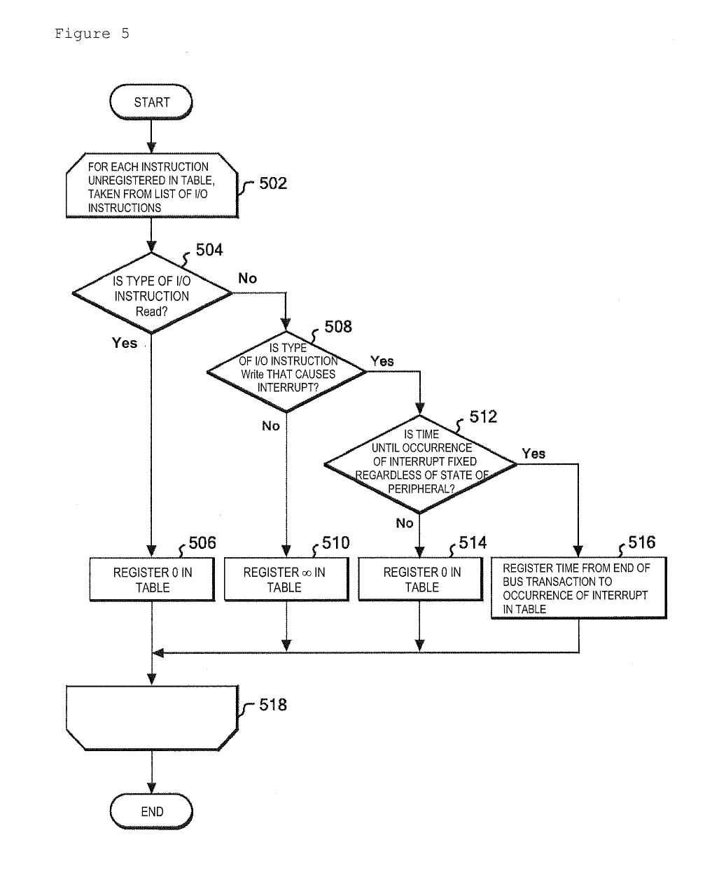

The second-stage table generation module 210 refers to the information obtained from the input of the specifications 208 to generate the second-stage table 212, which is then written to the hard disk drive 108 and stored therein. The process of generating the second-stage table 212 will be described below with reference to a flowchart in FIG. 5.

The plant simulator 214 simulates mechanical equipment in an automobile, for example power equipment such as an engine, power transmission equipment such as a transmission, traveling equipment such as a steering gear, or braking equipment.

The peripheral simulator 218 receives a continuous pulse signal from the plant simulator 214, converts the continuous pulse signal into an interrupt event signal, and inputs the interrupt event signal to the instruction set simulator 216, which is a processor emulator or an ECU emulator. The instruction set simulator 216 returns an I/O instruction to the peripheral simulator 218 in response to the interrupt event signal. The peripheral simulator 218 further converts the I/O instruction input from the peripheral simulator 218 into a pulse and inputs the pulse to the plant simulator 214.

The scheduler 220 has a function of giving a time, t, individually to the plant simulator 214, the instruction set simulator 216, and the peripheral simulator 218 to advance the simulators to that time, and a function of receiving a completion notification individually from the plant simulator 214, the instruction set simulator 216, and the peripheral simulator 218 upon completion.

A problem in the conventional art is the unpredictability of the timing with which the I/O instruction is provided from the instruction set simulator 216. In order to solve this problem, according to the present invention, the instruction set simulator 216 responds to a query from the scheduler 220 to look up the previously provided first-stage table 206 with reference to the value of its program counter and provide a predicted value of the timing of outputting the I/O instruction.

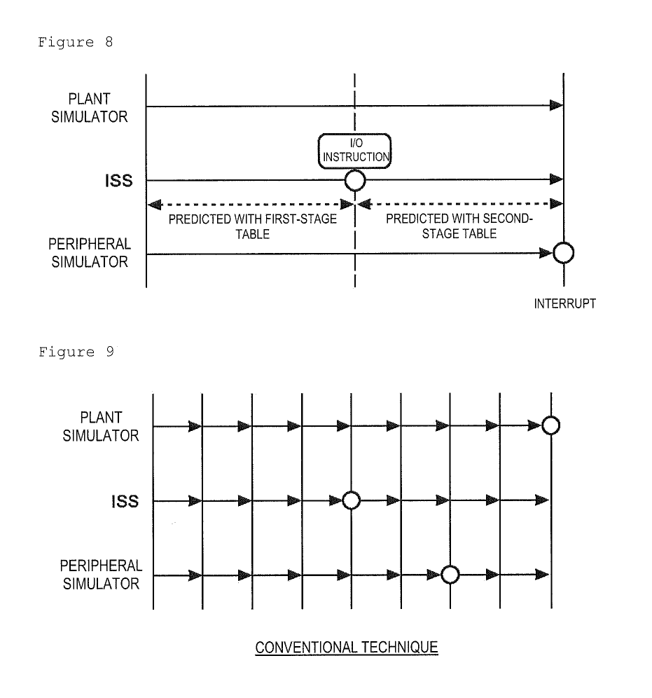

The instruction set simulator 216 further looks up the second-stage table 212 with reference to the type of the I/O instruction obtained by looking up the first-stage table 206 and obtains the value of the earliest time until an output event from the peripheral simulator. As shown in FIG. 8, the sum of the value of the predicted time until the arrival of the I/O instruction obtained by looking up the first-stage table 206 and the value of the earliest time until the output event from the peripheral simulator obtained by looking up the second-stage table 212 is a predicted time until the next event.

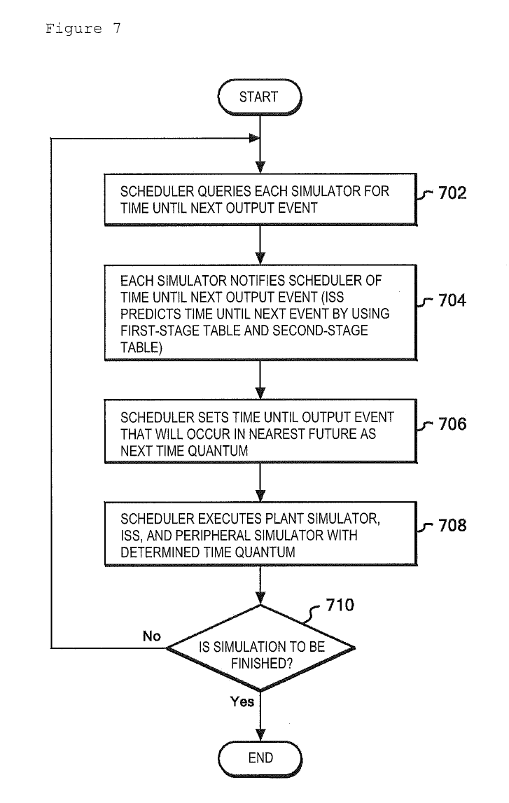

The process of performing a simulation with the first-stage table 206 and the second-stage table 212 being looked up will be described below with reference to a flowchart in FIG. 7.

Now, the process in which the first-stage table generation module 204 generates the first-stage table will be described with reference to flowcharts in FIGS. 3 and 4.

The first-stage table generation module 204 repeats steps 302 to 308 for each of all addresses at which the instruction set simulator (ISS) 216 may stop. There are two cases in which the instruction set simulator 216 must stop: when an interrupt is made by the peripheral simulator 218, and when a Read/Write command is output to the peripheral simulator 218. Since the peripheral simulator 218 is miming with the I/O clock, the instruction set simulator 216 receives an interrupt by the peripheral simulator 218 at an I/O clock boundary. Therefore the instruction set simulator 216 may stop in two points of time: “an I/O clock boundary” and “the timing of executing a Read/Write command” These points of time can be detected by statically analyzing the binary code for the instruction set simulator 216.

The first-stage table generation module 204 invokes a search routine in step 304. The search routine will be described below with reference to a flowchart in FIG. 4.

In step 306, the first-stage table generation module 204 determines the predicted time until the arrival of the I/O instruction based on the number of cycles charged in the search in step 304. The predicted time until the arrival of the I/O instruction is registered in a table, i.e., the first-stage table 206, along with the type of the next I/O instruction. FIG. 7 shows that the first-stage table 206 has three fields of “the program counter,” “the predicted time until the arrival of the I/O instruction,” and “the next I/O instruction,” and specific examples of their entries. Since the duration of one clock is known, the duration can be multiplied by the obtained number of cycles to acquire the predicted time until the arrival of the I/O instruction.

Step 308 is the end of the loop, where the process returns to step 302 until all the addresses at which the instruction set simulator (ISS) 216 may stop are traversed.

Now, the search routine in step 304 will be described with reference to a flowchart in FIG. 4.

The first-stage table generation module 204 fetches an instruction in step 402 and charges the number of cycles for the fetched instruction, that is, adds the number of cycles for the instruction to a predetermined variable in step 404. Here, the number of cycles for the instruction is the number of cycles that the instruction occupies.

In step 406, the first-stage table generation module 204 determines whether the fetched instruction is Load or Store. If so, the process proceeds to step 408, in which the range of target addresses of Load/Store is checked. For example, this is performed through the following processing. The processing is intended to check the range of addresses specified by the Load/Store in order to determine whether the Load/Store accesses are directed to the main memory or to the peripheral. The processing is represented as the following program code.

Given that the main memory of a CPU is mapped to the address range “0x00000000-0x10000000,” code for checking this is as follows.

if ((address >= 0x00000000) && (address <= 0x10000000)) {processing
for a case that the Load/Store is directed to the main memory
}
else {/*determine all accesses other than accesses to the main memory
as accesses to the peripheral*/
processing for a case that the Load/Store is directed to the peripheral
}

If, as the result of the above processing, the first-stage table generation module 204 determines in step 410 that the Load/Store is directed to the peripheral simulator 218, then in step 412, the first-stage table generation module 204 sets the number of charged cycles as a predicted number of cycles up to the next I/O instruction, and terminates the process.

If step 410 results in Unknown, that is, the determination is not possible from the addresses, it is conservatively determined that the Load/Store accesses are all directed to the peripheral simulator 218, and the processing in step 412 is performed.

If the first-stage table generation module 204 determines in step 410 that the Load/Store accesses are not directed to the peripheral simulator 218, it is determined whether the state is a CPU waiting state in step 414. The CPU waiting state may be busy loop, yield, or the like. If so, the process proceeds to step 416, in which the first-stage table generation module 204 sets the number of cycles up to the next I/O instruction to ∞, i.e., an unrealistically large value, and terminates the process.

If the first-stage table generation module 204 determines in step 414 that the state is not a CPU waiting state, it is determined in step 418 whether the fetched instruction is a branch instruction. If so, in step 420, the first-stage table generation module 204 searches the branch width by placing priority on the width. When a path with the fewest number of cycles up to the next I/O instruction is identified, the predicted number of cycles is set and the search for the branch destination is finished. Thus, the process terminates.

If the fetched instruction is not a branch instruction in step 418, the first-stage table generation module 204 advances the target analyzed address to the next instruction in step 422 and returns to step 402.

Now, the process in which the second-stage table generation module 210 generates the second-stage table 212 will be described with reference to a flowchart in FIG. 5.

In a loop from step 502 to step 518 in FIG. 5, the second-stage table generation module 210 processes each instruction unregistered in a table, i.e., the second-stage table 212, taken from a list of I/O instructions. Here, the instruction may be input by reading the instruction specifications one by one from the file in which the specifications are written, as illustrated by the block of input of specifications 208 in FIG. 2, or may be manually input by an operator with reference to the specifications. As another way of input, the second-stage table generation module 210 may display a data input panel. The panel may present choices such as those illustrated in the decision blocks in the flowchart in FIG. 5, so that entries may be filled by clicking on radio buttons as appropriate.

In step 504, the second-stage table generation module 210 determines whether the I/O instruction in question is of Read type. If so, the second-stage table generation module 210 registers 0 in the second-stage table 212 in step 506 and returns to step 502.

If the I/O instruction in question is not of Read type, the second-stage table generation module 210 determines in step 508 whether the I/O instruction in question is of Write type that causes interrupt. If not, no particular output event will occur, so that ∞ is registered in the second-stage table 212 in step 510, and the process returns to step 502.

If the I/O instruction in question is of Write type that causes interrupt, the second-stage table generation module 210 determines in step 512 whether the time until the occurrence of interrupt is fixed regardless of the state of the peripheral simulator 218. If not, 0 is registered in the second-stage table 212 in step 514, and the process returns to step 502.

If the time until the occurrence of interrupt is fixed regardless of the state of the peripheral simulator 218, the second-stage table generation module 210 registers the time from the end of bus transaction to the occurrence of interrupt in the second-stage table 212 according to the specifications in step 516, and the process returns to step 502.

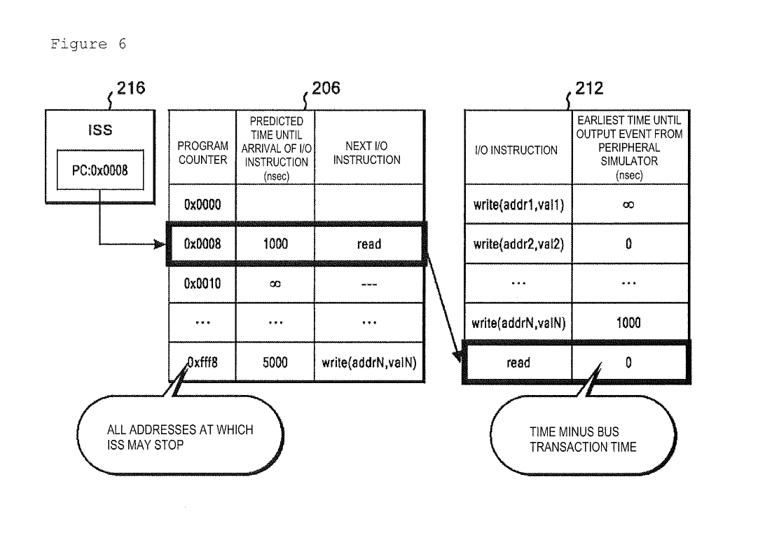

Finally, in response to an operation of the operator confirming that all expected I/O instructions have been processed, the second-stage table generation module 210 exits the loop in step 518 and terminates the process. FIG. 6 shows exemplary entries in the second-stage table 212 generated as a result of this process.

Now, simulation operations with the first-stage table 206 and the second-stage table 212 will be described with reference to a flowchart in FIG. 7.

In step 702 in FIG. 7, the scheduler 220 queries each of the simulators, i.e., the plant simulator 214, the peripheral simulator 218, and the instruction set simulator 216, for the time until the next output event.

In step 704, at the point of receiving this input, the plant simulator 214 and the peripheral simulator 218 each have pre-calculated the time until the output event, and therefore notify the scheduler 220 of the time. The instruction set simulator 216, which originally could not pre-calculate the time until the output event, refers to the value of its own program counter at the point of receiving the query from the scheduler 220 and looks up the first-stage table 206. The instruction set simulator 216 uses the resultant entry of “the next I/O instruction” to look up the second-stage table 206. The instruction set simulator 216 returns, as the time until the next output event, the sum of the value of “the predicted time until the arrival of the I/O instruction” obtained by looking up the first-stage table 206 and the value of “the earliest time of an output event from the peripheral simulator” obtained by looking up the second-stage table 212. This is illustrated in a timing diagram in FIG. 8.

Next, in step 706, the scheduler 220 sets the time until an output event that will occur in the nearest future as the next time quantum.

In step 708, the scheduler 220 executes the plant simulator 214, the instruction set simulator 216, and the peripheral simulator 218 with the time quantum determined in step 706.

In step 710, it is determined whether the simulation is to be finished. If so, the simulation is finished. Otherwise, the process returns to step 702 to continue the simulation.

FIG. 9 shows a timing diagram of a conventional simulation system for comparison. In the conventional technique, the timing with which the instruction set simulator 216 outputs the I/O instruction cannot be predicted. Consequently, the plant simulator 214, the instruction set simulator 216, and the peripheral simulator 218 need to be synchronized for each clock of the system, which apparently reduces the simulation speed.

In the above embodiment, both the first-stage table 206 and the second-stage table 212 are used as shown in FIG. 6. However, a certain object can be accomplished by using only the first-stage table 206 and not using the second-stage table 212. In this case, in response to the query from the scheduler 220, the instruction set simulator 216 looks up the first-stage table 206 to obtain the value of “the predicted time until the arrival of the I/O instruction” and returns the time as the time until the next event to the scheduler 220. In the embodiment involving the use of only the first-stage table 206, “the next I/O instruction” field is unnecessary. In the embodiment without the second-stage table 212, the first-stage table may be called an event prediction table.

Generally, an automobile system has a plurality of ECUs. Therefore its simulation system will have a plurality of instruction set simulators correspondingly. In this case, the first-stage table and the second-stage table will be provided for each instruction set simulator.

Thus, the embodiments of the present invention have been described with respect to the particular examples. The present invention can be implemented on any multitask-capable platform without being limited to particular computer architectures or platforms.

1. A method for controlling a simulation system including a plant simulator, an instruction set simulator, a peripheral simulator, and a scheduler that run on a computer, wherein an interrupt signal is input to the instruction set simulator, the instruction set simulator inputs an I/O instruction to the peripheral simulator, the peripheral simulator inputs a pulse signal to the plant simulator, and the scheduler provides an instruction to advance operations of the plant simulator, the instruction set simulator, and the peripheral simulator, the method comprising:
storing, in a storage device of the computer, a first-stage table in which a value of a predicted time until arrival of an I/O instruction and a type of the I/O instruction are included as entries for each program counter of the instruction set simulator;
storing, in the storage device of the computer, a second-stage table in which a value of an earliest time until an output event from the peripheral simulator is included as an entry for each type of I/O instruction;
the scheduler querying the plant simulator, the instruction set simulator, and the peripheral simulator for a next event time;
the plant simulator returning a pre-calculated next event time in response to the query from the scheduler;
the peripheral simulator returning a pre-calculated next event time in response to the query from the scheduler;
the instruction set simulator, in response to the query from the scheduler, looking up the first-stage table with reference to a value of the program counter to obtain the type of the I/O instruction and the value of the predicted time until arrival of the I/O instruction, looking up the second-stage table with reference to the obtained type of the I/O instruction to obtain the value of the earliest time until the output event from the peripheral simulator, and returning a sum of the value of the predicted time until arrival of the I/O instruction and the value of the earliest time until the output event from the peripheral simulator as a next event time; and
the scheduler advancing a simulation to an earliest event time among the next event times returned from the plant simulator, the instruction set simulator, and the peripheral simulator.

2. The method according to claim 1, wherein the first-stage table is generated through static analysis of binary code executed by the instruction set simulator.

3. The method according to claim 2, wherein the entries of the first-stage table are generated for each instruction address at which the instruction set simulator may stop.

4. A non-transitory, computer readable medium containing computer readable instructions stored thereon that, when executed by a computer, implement a method for controlling a simulation system including a plant simulator, an instruction set simulator, a peripheral simulator, and a scheduler that run on a computer, wherein an interrupt signal is input to the instruction set simulator, the instruction set simulator inputs an I/O instruction to the peripheral simulator, the peripheral simulator inputs a pulse signal to the plant simulator, and the scheduler provides an instruction to advance operations of the plant simulator, the instruction set simulator, and the peripheral simulator, wherein the method comprises:
storing, in a storage device of the computer, a first-stage table in which a value of a predicted time until arrival of an I/O instruction and a type of the I/O instruction are included as entries for each program counter of the instruction set simulator;
storing, in the storage device of the computer, a second-stage table in which a value of an earliest time until an output event from the peripheral simulator is included as an entry for each type of I/O instruction;
the scheduler querying the plant simulator, the instruction set simulator, and the peripheral simulator for a next event time;
the plant simulator returning a pre-calculated next event time in response to the query from the scheduler;
the peripheral simulator returning a pre-calculated next event time in response to the query from the scheduler;
the set simulator, in response to the query from the scheduler, looking up the first-stage table with reference to a value of the program counter to obtain the type of the I/O instruction and the value of the predicted time until arrival of the I/O instruction, looking up the second-stage table with reference to the obtained type of the I/O instruction to obtain the value of the earliest time until the output event from the peripheral simulator, and returning a sum of the value of the predicted time until arrival of the I/O instruction and the value of the earliest time until the output event from the peripheral simulator as a next event time; and
the scheduler advancing a simulation to an earliest event time among the next event times returned from the plant simulator, the instruction set simulator, and the peripheral simulator.

5. The computer readable medium according to claim 4, wherein the first-stage table is generated through static analysis of binary code executed by the instruction set simulator.

6. The computer readable medium according to claim 5, wherein the entries of the first-stage table are generated for each instruction address at which the instruction set simulator may stop.

7. A simulation system, comprising:
a plant simulator, an instruction set simulator, a peripheral simulator, and a scheduler that run on a computer, wherein an interrupt signal is input to the instruction set simulator, the instruction set simulator inputs an I/O instruction to the peripheral simulator, the peripheral simulator inputs a pulse signal to the plant simulator, and the scheduler provides an instruction to advance operations of the plant simulator, the instruction set simulator, and the peripheral simulator;
a storage device;
a first-stage table stored in the storage device and including a value of a predicted time until arrival of an I/O instruction and a type of the I/O instruction as entries for each program counter of the instruction set simulator;
a second-stage table stored in the storage device of the computer and including a value of an earliest time until an output event from the peripheral simulator as an entry for each type of I/O instruction;
the scheduler having a function of querying the plant simulator, the instruction set simulator, and the peripheral simulator for a next event time;
the plant simulator having a function of returning a pre-calculated next event time in response to the query from the scheduler;
the peripheral simulator having a function of returning a pre-calculated next event time in response to the query from the scheduler; and
the instruction set simulator having a function of, in response to the query from the scheduler, looking up the first-stage table with reference to a value of the program counter to obtain the type of the I/O instruction and the value of the predicted time until arrival of the I/O instruction, looking up the second-stage table with reference to the obtained type of the I/O instruction to obtain the value of the earliest time until the output event from the peripheral simulator, and returning a sum of the value of the predicted time until arrival of the I/O instruction and the value of the earliest time until the output event from the peripheral simulator as next event time, wherein the scheduler further has a function of advancing a simulation to an earliest event time among the next event times returned from the plant simulator, the instruction set simulator, and the peripheral simulator.

8. The system according to claim 7, wherein the first-stage table is generated through static analysis of binary code executed by the instruction set simulator.

9. The system according to claim 8, wherein the entries of the first-stage table are generated for each instruction address at which the instruction set simulator may stop.

10. A method for controlling a simulation system including a plant simulator, an instruction set simulator, a peripheral simulator, and a scheduler that run on a computer, wherein an interrupt signal is input to the instruction set simulator, the instruction set simulator inputs an I/O instruction to the peripheral simulator, the peripheral simulator inputs a pulse signal to the plant simulator, and the scheduler provides an instruction to advance operations of the plant simulator, the instruction set simulator, and the peripheral simulator, the method comprising:
storing, in a storage device of the computer, an event prediction table in which a value of a predicted time until arrival of an I/O instruction is included as an entry for each program counter of the instruction set simulator;
the scheduler querying the plant simulator, the instruction set simulator, and the peripheral simulator for a next event time;
the plant simulator returning a pre-calculated next event time in response to the query from the scheduler;
the peripheral simulator returning a pre-calculated next event time in response to the query from the scheduler;
the instruction set simulator, in response to the query from the scheduler, looking up the event prediction table with reference to a value of the program counter to obtain the value of the predicted time until arrival of the I/O instruction and returning the obtained value as a next event time; and
the scheduler advancing a simulation to an earliest event time among the next event times returned from the plant simulator, the instruction set simulator, and the peripheral simulator.

11. The method according to claim 10, wherein the event prediction table is generated through static analysis of binary code executed by the instruction set simulator.

12. The method according to claim 11, wherein the entry of the event prediction table is generated for each instruction address at which the instruction set simulator may stop.

13. A non-transitory, computer readable medium containing computer readable instructions stored thereon that, when executed by a computer, implement a method for controlling a simulation system including a plant simulator, an instruction set simulator, a peripheral simulator, and a scheduler that run on a computer, wherein an interrupt signal is input to the instruction set simulator, the instruction set simulator inputs an I/O instruction to the peripheral simulator, the peripheral simulator inputs a pulse signal to the plant simulator, and the scheduler provides an instruction to advance operations of the plant simulator, the instruction set simulator, and the peripheral simulator, wherein the method comprises:
storing, in storage device of the computer, an event prediction table in which a value of a predicted time until arrival of an I/O instruction is included as an entry for each program counter of the instruction set simulator;
the scheduler querying the plant simulator, the instruction set simulator, and the peripheral simulator for a next event time;
the plant simulator returning a pre-calculated next event time in response to the query from the scheduler;
the peripheral simulator returning a pre-calculated next event time in response to the query from the scheduler;
the instruction set simulator, in response to the query from the scheduler, looking up the event prediction table with reference to a value of the program counter to obtain the value of the predicted time until arrival of the I/O instruction and returning the obtained value as a next event time; and
the scheduler advancing a simulation to an earliest event time among the next event times returned from the plant simulator, the instruction set simulator, and the peripheral simulator.

14. The program according to claim 13, wherein the event prediction table is generated through static analysis of binary code executed by the instruction set simulator.

15. The program according to claim 14, wherein the entry of the event prediction table is generated for each instruction address at which the instruction set simulator may stop.
